(19) United States
(12) Patent Application Publication
(10) Pub. No.: US 2021/0178817 A1
(43) Pub. Date: Jun. 17, 2021

(54) PNEUMATIC TIRE

(71) Applicant: The Goodyear Tire & Rubber Company, Akron, OH (US)

(72) Inventors: Marco Nicolò Coccon, Luxembourg Ville (LU); Ettore Passante Spaccapietra, Ettelbruck (LU); Arun Prasath Manogaran, Everlange (LU); Didier Winkin, Bastogne (BE); Roland Willibrord Krier, Wasserbillig (LU); Philippe Joseph Auguste Muller, Champlon (BE); Peter Johann Cornelius Maus, Büllingen (BE); Vaibhav Nawale, Boevange-sur-Attert (LU)

(21) Appl. No.: 17/070,353

(22) Filed: Oct. 14, 2020

Related U.S. Application Data
(60) Provisional application No. 62/949,109, filed on Dec. 17, 2019.

(51) Int. Cl. B60C 9/20

(52) U.S. Cl. CPC B60C 9/20; B60C 2200/06; B60C 2009/2019; B60C 2009/2016

(57) ABSTRACT

A pneumatic tire is described which includes a tread, a carcass and a belt structure interposed between the carcass and the tread. The belt structure includes a first and second working belt, wherein the angle of the working belts range from about 12 degrees to about 35 degrees, wherein the belt structure further includes a low angle belt located radially inward of the working belts. The first working belt is the radially innermost working belt, and is the widest belt. The second working belt is the radially outermost belt. The pneumatic tire may further include a second optional low angle belt, that is located between the first low angle belt and the first working belt.

### FIELD OF THE INVENTION

This invention relates to a pneumatic tire having a carcass and a belt reinforcing structure, and, more particularly, to radial ply tires for use in aircraft, trucks and other high load applications.

### BACKGROUND OF THE INVENTION

The commercial truck market is moving towards an increase in overall vehicle weight, which is due in part to the increase in weight of the motor and equipment. The increase in overall vehicle weight requires a tire capable of handling the additional loading. Thus, a tire with improved crown durability and increased load carrying capacity is desired.

### SUMMARY OF THE INVENTION

The invention provides in a first aspect a pneumatic tire comprising a tread, a carcass and a belt structure interposed between the carcass and the tread. The belt structure includes a first and second working belt which are the radially outermost belts. A low angle belt is positioned radially inward of the first and second working belts, and wherein the low angle belt has an angle less than 10 degrees. The first and second working belts are the widest belts, and are formed of extensible reinforcements.

### Definitions

“Apex” means a non-reinforced elastomer positioned radially above a bead core.

“Aspect ratio” of the tire means the ratio of its section height (SH) to its section width (SW) multiplied by 100% for expression as a percentage.

“Axial” and “axially” mean lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Bias ply tire” means a tire having a carcass with reinforcing cords in the carcass ply extending diagonally across the tire from bead core to bead core at about a 25-50 degree angle with respect to the equatorial plane of the tire. Cords run at opposite angles in alternate layers.

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Chafers” refer to narrow strips of material placed around the outside of the bead to protect cord plies from the rim, distribute flexing above the rim, and to seal the tire.

“Chippers” mean a reinforcement structure located in the bead portion of the tire.

“Cord” means one of the reinforcement strands of which the plies in the tire are comprised.

“Extensible” means a cable having a relative elongation at break of greater than 0.2% at 10% of the breaking load, when measured from a cord extracted from a cured tire.

“Equatorial plane (EP)” means the plane perpendicular to the tire's axis of rotation and passing through the center of its tread.

“Flipper” means a reinforced fabric wrapped about the bead core and apex.

“Footprint” means the contact patch or area of contact of the tire tread with a flat surface at zero speed and under normal load and pressure

“Innerliner” means the layer or layers of elastomer or other material that form the inside surface of a tubeless tire and that contain the inflating fluid within the tire.

“Net-to-gross ratio” means the ratio of the tire tread rubber that makes contact with the road surface while in the footprint, divided by the area of the tread in the footprint, including non-contacting portions such as grooves.

“Radial-ply tire” means a belted or circumferentially-restricted pneumatic tire in which the ply cords which extend from bead to bead are laid at cord angles between 65-90 degrees with respect to the equatorial plane of the tire.

“Section height” (SH) means the radial distance from the nominal rim diameter to the outer diameter of the tire at its equatorial plane.

“Winding” means the pattern of the strip formed in a first revolution of the strip around a tire building drum, tire or core.

### BRIEF DESCRIPTION OF THE DRAWINGS

The invention will be described by way of example and with reference to the accompanying drawings in which:

FIG. 1 illustrates a partial cross-section through the tire midplane of an exemplary radial tire 10 of the present invention;

FIG. 2 illustrates a cross-sectional view of a first embodiment of a tire belt package;

FIG. 3 illustrates a cross-sectional view of a second embodiment of a tire belt package;

FIG. 4 illustrates a cross-sectional view of a third embodiment of a tire belt package;

FIG. 5 illustrates a top view of a first embodiment of belt layup shown on a tire building drum from 0 to 360 degrees of the drum shown; and

FIG. 6 illustrates a top view of a second embodiment of belt layup shown on a tire building drum from 0 to 360 degrees of the drum shown.

### DETAILED DESCRIPTION OF AN EXAMPLE EMBODIMENT THE INVENTION

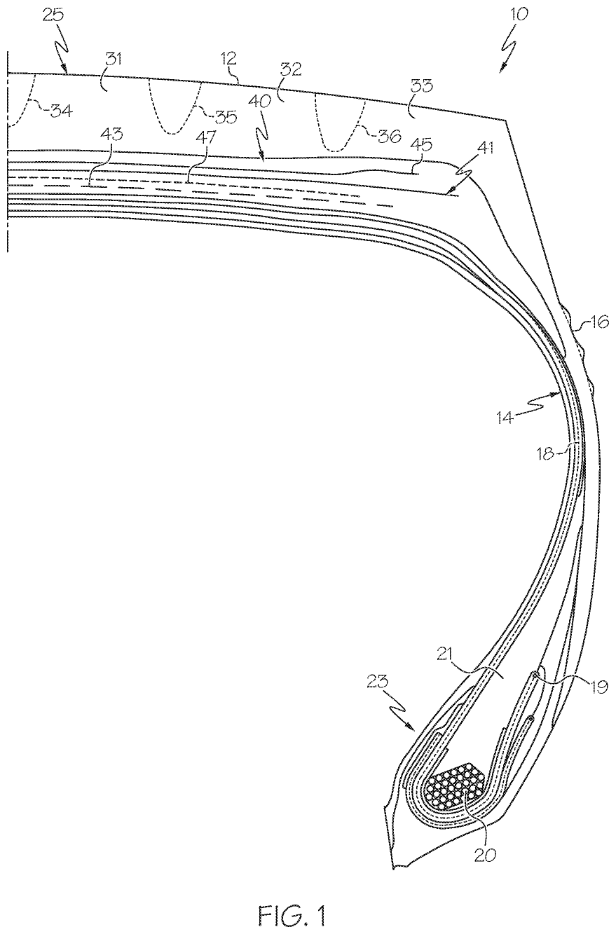

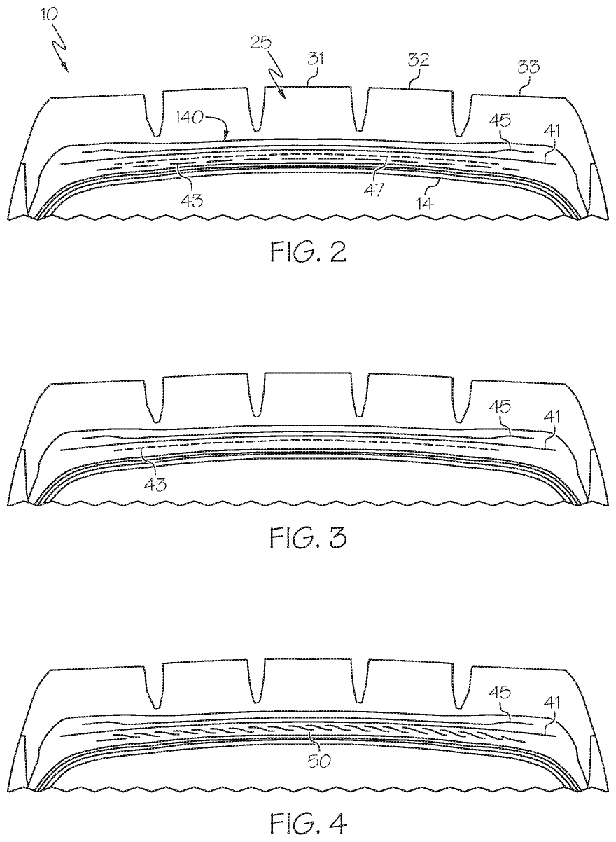

FIGS. 1-2 illustrates a partial cross-section of an exemplary radial tire 10 which includes a bead portion 23 having a bead core 20 embedded therein, a sidewall portion 16 extending radially outward from the bead portion 23, and a cylindrical tread portion 25 extending between radially outer ends of the sidewall portions 16. The tread 25 may include a plurality of ribs 31,32 and shoulder lugs 33 with optional grooves 34,35,36 located between the ribs. The tire 10 includes an inner liner 14 and is reinforced by one or more carcass plies 18 toroidally extending from one bead portion 23 to the other bead portion (not shown). The carcass ply 18 is preferably anchored to the bead core and for example, may wind around each bead core 20 from inside of the tire 10 away from the equatorial plane EP to form a turnup portion 19. A belt reinforcement package 40 is arranged between the carcass ply 18 and the tread portion 25.

The belt reinforcement package 40, according to an example embodiment of the present invention, includes a first and second working belt, 41, 45. The first working belt 41 is preferably the radially innermost belt of the two working belts, and is the widest belt of the belt reinforcement package 40. Preferably, the first working belt 41 has a belt width substantially equal to the tread arc width. The breaker angle of first working belt 41 is between about 12 and 45 degrees, preferably with a left orientation, more preferably in the range of about 19 to about 30 degrees. The belt angles are measured with respect to the circumferential direction.

The second working belt 45 is located radially outward of the first working belt, and is the radially outermost belt of the belt package. The second working belt 45 preferably has a width in the range of 70% to 90% of the tread arc width. The second working belt 45 has a breaker angle between about 12 and 45 degrees, preferably with a right orientation, more preferably in the range of about 19 to about 30 degrees. The second working belt 45 is preferably made of the same wire as belt 41, and has the same construction with the same but opposite angular orientation as 41.

The first and second working belts 41,45 are preferably made of steel. The % elongation at 10% of breaking load of the first and second working belts 41,45 may range from about 0.18 to about 0.26. Preferably, the working belts 41,45 are formed of extensible reinforcements, so that the reinforcements have a % elongation at 10% of breaking load is greater than 0.2. The % elongation is measured on a cord extracted from a vulcanized tire.

As shown in FIG. 3, the belt package 40 may additionally include a single low angle belt 43, that is preferably helically wound and has a belt angle of less than 10 degrees, and more preferably less than 5 degrees. The low angle belt 43 is preferably located radially inward of both of the first and second working belts 41,45. The low angle belt 43 preferably is narrower in axial width than the first working belt 41 and the second working belt 45. Preferably, the low angle belt 43 is the narrowest belt. The low angle belt 43 is preferably formed from a reinforced strip of one or more cords, wherein the width of the strip is in the range of 3 to 20 mm, and more preferably in the range of 3 to 8 mm. The low angle belt structure 39 may be formed from using any of the patterns as further described below. As shown in FIGS. 1-2, the belt package 40 may include an optional second low angle belt 47, wherein the second low angle belt 47 is positioned between the first working belt 41 and the first low angle belt 43. The second low angle belt 47 preferably has a width narrower than the first working belt 41 and the first low angle belt 43.

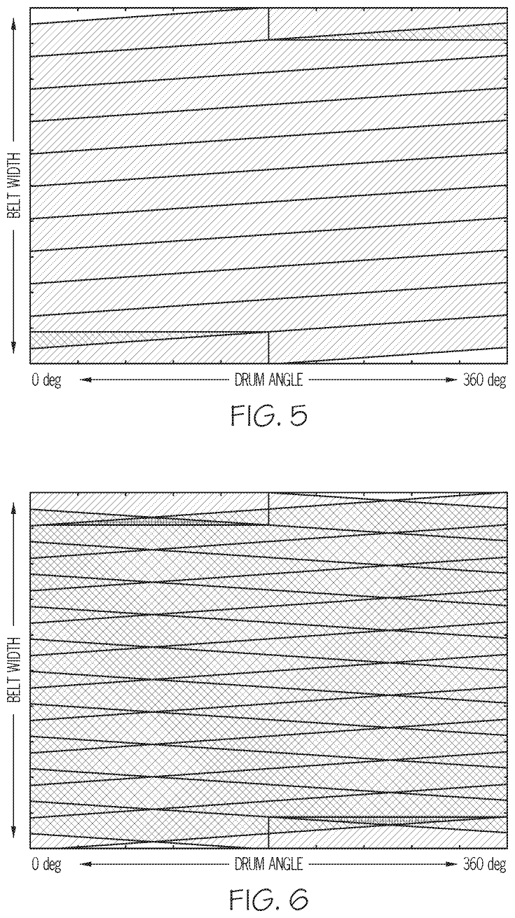

A first embodiment of a belt layup for the low angle belt 43 is shown in FIG. 5. FIG. 5 illustrates the belt formation on the tire building drum which is shown as flat for illustration purposes, from 0 to 360 degrees. This pattern spirally winds a rubberized strip of one or more parallel cords on a tire building drum or former. Preferably, the strip uses at least three parallel reinforcement cords, and preferably has a strip width of 3 to 30 mm, and more particularly 5 to 7 mm. The low angle belt is formed by starting the strip at a first drum end or left shoulder of the tire building drum at a zero degree angle with the circumferential direction, wherein the strip laterally shifts over one strip width after 360 degrees rotation of the drum. The strip is then wound on the drum as the drum rotates to the opposite shoulder or side of the drum. The strips may be wound with a gap between windings or overlapped. The strip may be wound in such a manner to form a single or double layer forming a low angle belt. FIG. 4 illustrates a double layer of a low angle belt 50 formed using the STS pattern, wherein the strips are overlapped as they are wound on the tire building drum.

A second embodiment of the low angle belt 43 construction is shown in FIG. 6. FIG. 6 illustrates the belt formation on the tire building drum which is shown as flat for illustration purposes, from 0 to 360 degrees. Starting at the center line of the drum, a strip of reinforcement cords is wrapped onto the building drum to the right shoulder of the drum at a first angle, wherein the first angle is less than 10 degrees with the circumferential direction. The strip is then wound from the first shoulder to the second shoulder of the drum at a second angle, wherein the second angle is negative and less than 10 degrees with the circumferential direction, and then back to the center. Thus the strip is wound from one shoulder to the other shoulder in a zigzag manner, wherein the angle of the strip is less than 10 degrees. A positive gap or spacing may be placed in between consecutive adjacent segments of the strip, acting like a separator.

The belt width of the low angle belt 43 is preferably in the range of about 70% to about 80% of the tread arc width, and even more preferably in the range of 73-77%. The low angle belt 43 may be steel, and may be formed of high elongation reinforcements or extensible reinforcements. The reinforcements may be a high elongation construction such as, for example, 3×7×0.22 HE, and having an EPI of about 14. The high elongation wire may have a % elongation at 10% of the breaking load ranging from about 1.7-2.05% for a bare, green cord. The high elongation wire may have a % elongation at 10% of the breaking load ranging from about 0.45-0.68% taken from cured tire. Another example of a cord construction suitable for the invention is made of steel having a 4×7×26 HE construction, with an EPI of 18.

The aspect ratio of the tire described above may vary. The aspect ratio is preferably in the range of about 50 to about 90. The tire may have a net to gross ratio in the range of about 70 to about 90, more preferably in the range of about 74 to about 86, more preferably about 78 to 84.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire comprising a tread, a carcass and a belt structure interposed between the carcass and the tread, wherein the belt structure includes a first and second working belt, wherein the second working belt is located radially outward of the first working belt wherein a low angle belt is positioned radially inward of the first working belt, and wherein the low angle belt has an angle less than 10 degrees.

2. The pneumatic tire of claim 1 wherein the angle of the first and second working belts range from about 12 degrees to about 35 degrees.

3. The pneumatic tire of claim 1 wherein the first working belt has a width about equal to the tread arc width.

4. The pneumatic tire of claim 1 wherein the second working belt has a width less than the first working belt.

5. The pneumatic tire of claim 1 wherein the first working belt is formed of reinforcements that are extensible.

6. The pneumatic tire of claim 1 wherein the second working belt is formed of reinforcements that are extensible.

7. The pneumatic tire of claim 1 further comprising a third working belt.

8. The pneumatic tire of claim 1 wherein the third working belt is the radially outermost belt.

9. The pneumatic tire of claim 1 wherein the third working belt is formed of reinforcements that are extensible.

10. The pneumatic tire of claim 1 wherein the first and second lateral belts are integrally formed with the low angle belt.

11. The pneumatic tire of claim 1 wherein the width of the first lateral belt is in the range of 10% to 50% of the tread arc width.

12. The pneumatic tire of claim 1 wherein the width of the first lateral belt is in the range of 10% to 30% of the tread arc width.

13. The pneumatic tire of claim 1 wherein the width of the second lateral belt is in the range of 10% to 50% of the tread arc width.

14. The pneumatic tire of claim 1 wherein the width of the second lateral belt is in the range of 10% to 30% of the tread arc width.
